(19) United States
(12) Patent Application Publication
(10) Pub. No.: US 2026/0112373 A1
(43) Pub. Date: Apr. 23, 2026

(54) DEEPFAKE DETECTION IN COMMUNICATION SESSIONS BASED ON VOICE SAMPLES

(71) Applicant: T-Mobile USA, Inc., Bellevue, WA (US)

(72) Inventors: Mark J. Bonn, Granite Bay, CA (US); Dominick Mangiardi, Fremont, CA (US); Victoria Cook, Kansas City, MO (US); Dinko Dinkov, Kirkland, WA (US); Nauhman N. Gora, Irvine, CA (US)

(21) Appl. No.: 18/924,660

(22) Filed: Oct. 23, 2024

(51) Int. Cl. G10L 17/26; G10L 19/16; H04L 65/1016; H04M 3/42

(52) U.S. Cl. CPC G10L 17/26; G10L 19/167; H04L 65/1016; H04M 3/42042; H04M 2203/6045

(57) ABSTRACT

Described herein are one or more computing devices determining, based on voice verification models, that a voice audio sample of a calling party engaging in a communication session includes characteristics of a deepfake-generated voice. In response to determining that the voice audio sample includes characteristics of a deepfake-generated voice, the one or more computing devices alert the called party about the deepfake-generated voice.

### BACKGROUND

Deepfake voice calls, such as those generated by artificial intelligence (AI), are increasingly difficult to detect. The sophistication of the technology is such that family members are often misled into thinking that a deepfake is their loved one. Grandparents have received calls posing as their grandchildren asking for money. Employees have received calls from their supervisors instructing them to transfer money. In many such cases, detecting that the caller is a deepfake may be beyond the capacity of the call recipient. While there are safeguards for detecting suspicious phone numbers that may eliminate some of the threats posed by these deepfake calls (e.g., by labeling a call as “scam likely”), some calls will still be answered.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIG. 1 shows an overview diagram of a communication session that includes deepfake calling party pretending to be someone it is not and components of a telecommunication network capable of detecting the deepfake-generated voice of the calling party and alerting the called party about the deepfake-generated voice.

FIG. 2 is a network architecture diagram showing components of a telecommunication network capable of detecting a deepfake-generated voice of a calling party and alerting the called party about the deepfake-generated voice.

FIG. 3 is a flow diagram of an illustrative process for determining, based on voice verification models, that a voice audio sample of a calling party engaging in a communication session includes characteristics of a deepfake-generated voice and, in response, alerting the called party about the deepfake-generated voice.

FIG. 4 is a schematic diagram of a computing device capable of implementing functionality of at least one of the components illustrated in FIG. 1 or FIG. 2.

### DETAILED DESCRIPTION

This disclosure is directed in part to determining, based on voice verification models, that a voice audio sample of a calling party engaging in a communication session includes characteristics of a deepfake-generated voice. In response to determining that the voice audio sample includes characteristics of a deepfake-generated voice, computing device(s) alert the called party about the deepfake-generated voice.

As used herein, “deepfake-generated voice” refers to voice audio that does not come from a human being but which sounds like or impersonates a human. In many examples, the deepfake-generated voice impersonates a specific human. The deepfake-generated voice may be created using artificial intelligence (AI) or other technological mechanism(s).

Further, as used herein, a “communication session” may include any sort of communication between at least two parties that includes voice. For example, a voice call is a “communication session.” Other sorts of voice communication may also be “communication sessions.” The terms “calling party” and “called party” are used for a party initiating a communication session and a party answering that initiation, respectively. They may be a caller and callee of a voice call. They may also be initiator and receiver of a voice communication that is not a call, even though they are still identified, conforming to common parlance, as the “calling party” and “called party.”

In various implementations, an Internet Protocol Multimedia Subsystem (IMS) of either the calling party's telecommunication network or the called party's telecommunication network (which, in some instances, may be the same telecommunication network) may fork data for the communication session initiated by the called party (e.g., fork a Real-time Transport Protocol (RTP) stream) to sampling component(s) to record a sample or “snippet” of voice audio (e.g., the first 1.5 to 5 seconds of the communication session) and encode that sample for use by a deepfake detection component. Both the captured and encoded voice audio samples may be discarded after use to ensure privacy of the communication session participants.

The deepfake detection component may rely on one or more voice verification models that look for biometric markers in the voice audio sample. For instance, the voice verification models may be used to analyze pitch, harmonics, resonant harmonics, intensity, rhythms, spacing between words, pronunciations, etc. The voice verification models can be used to confirm a voice audio sample is likely from a human or confirm that a voice audio sample is likely not from a human. With either approach, if the result indicates a non-human voice (i.e., deepfake-generated voice), the deepfake detection component may send an indication to a security service of the telecommunication network (e.g., scam security service) or send an alert directly to the called party.

In some implementations, the called party has an ability to opt-in to receiving alerts of deepfake-generated voice and may only receive such alerts if the called party opts in. A called party that opts in may receive the alert as a notification, tone, or haptic output (e.g., vibration). In sone examples, the communication session may also be terminated. Further, in various instances, the called party may configure what actions are taken (e.g., alert, call termination, etc.) through an application on the called party's device or through, e.g., a web portal.

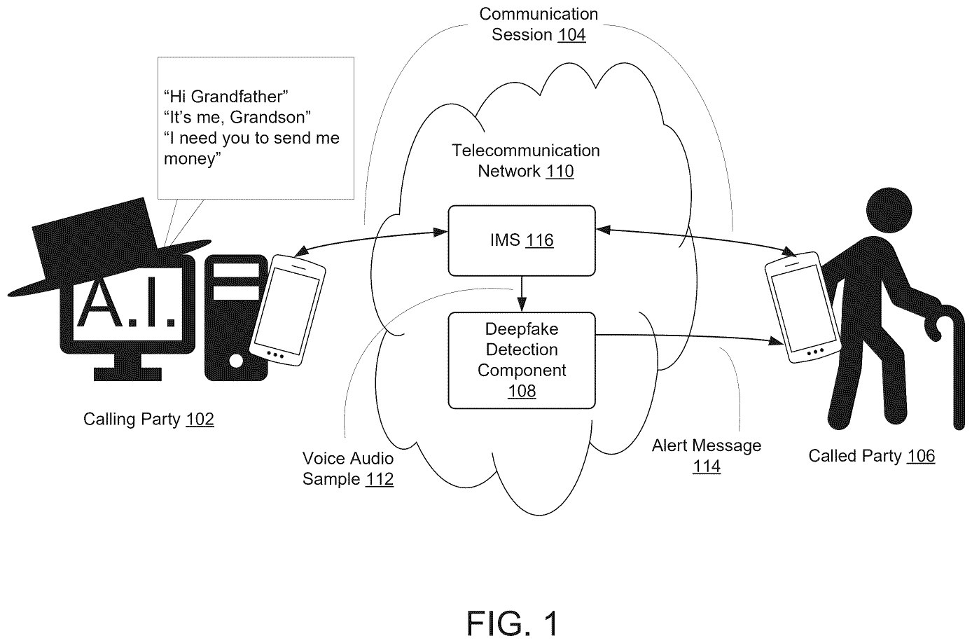

FIG. 1 shows an overview diagram of a communication session that includes deepfake calling party pretending to be someone it is not and components of a telecommunication network capable of detecting the deepfake-generated voice of the calling party and alerting the called party about the deepfake-generated voice. As illustrated, a deepfake calling party 102 (also referred to herein as calling party 102) may initiate a communication session 104 (e.g., a voice all) with a called party 106. Deepfake detection components 108 of the telecommunication network 110 supporting the communication session 104 may determine that a voice audio sample 112 from the communication session 104 includes deepfake-generated voice and, in response, may send an alert message 114 to the called party 106 of the communication session 104 about the deepfake voice. The voice audio sample 112 utilized by the deepfake detection components 108 may be captured by an IMS 116 of the telecommunication network 110.

The calling party 102 includes at least a source of a non-human voice being posed as a human voice. Such a source may be an AI or other technology mechanism capable of generating speech in a human voice. The AI or mechanism may have been trained on a large corpus of human speech samples to be able to generate a very realistic impersonation of human voice. If the AI or mechanism is posing as a specific person, some sample of that person's voice may have been used in generating the voice audio.

It is worth noting that while FIG. 1 shows a user equipment (UE) external to a computer hosting an AI, the UE and computer may be the same device or multiple devices connected by a network.

The recipient of the communication session 104—the called party 106—may be a human receiving the communication session 104 through a UE.

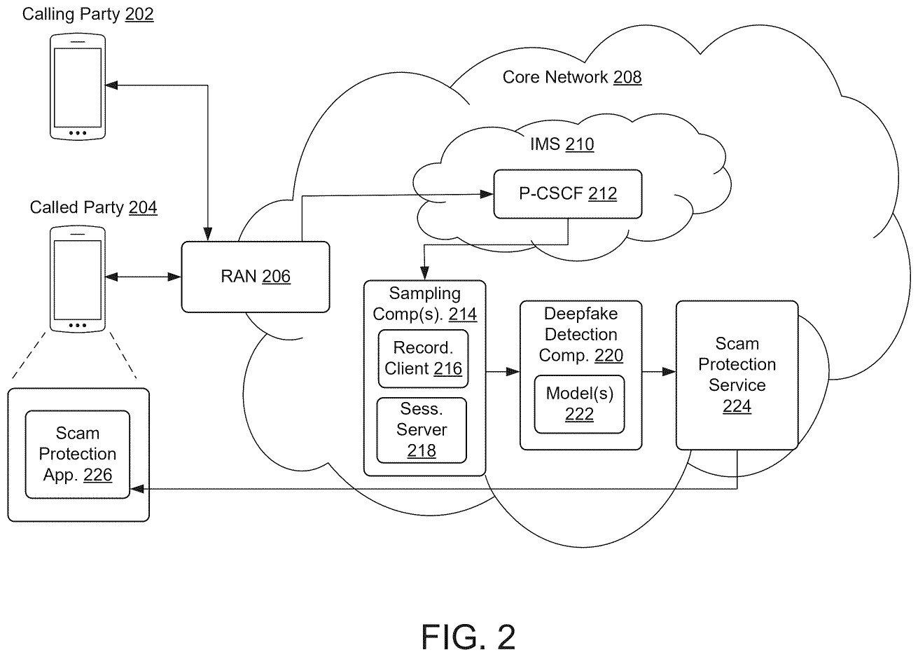

The telecommunication network 110 hosting the communication session 104 and including the deepfake detection components 108 may be any sort of telecommunication network and may have an architecture such as that illustrated in FIG. 2. The telecommunication network 110 may include at least access network(s) that the calling party 102 and called party 106 connect to and a core network for transport, authentication, and services for connected devices and networks. The core network may include the IMS 116.

As noted elsewhere herein, the communication session 104 may be voice call (e.g., a voice over Long Term Evolution (VOLTE) voice call or voice over New Radio (VONR) voice call) or any other sort of communication among two or more parties that includes voice audio. In some examples, the data of the communication session 104, at least from the calling party 102, may be an RTP stream. The setup of that communication session 104 may utilize session initiation protocol (SIP) signaling and radio bearers.

In various implementations, the voice audio sample 112 may be any data capable of representing voice audio from a calling party 102 from an initial period (e.g., first 1.5-5 seconds) of the communication session 104 and the alert message 114 may be any sort of signal capable of causing an alert on a device (e.g., UE) of the called party 106, of terminating the communication session 104, or of causing a response determining that the communication session 104 includes deepfake-generated voice.

While FIG. 1 shows IMS 116 as capturing the voice audio sample 112, any component(s) of the telecommunication network 110 sufficiently early in a transport chain between the calling party 102 and called party 106 may provide a hook into the data of the communication session 104 and may, e.g., fork that data (i.e., fork the RTP stream) to sampling component(s) (described and shown in FIG. 2). Within the IMS 116, the P-CSCF may be the node responsible for capturing the voice audio.

The deepfake detection components 108 may take a voice audio input, such as the voice audio sample 112, and by applying voice verification models using, e.g., biometric markers, may determine that the voice audio sample 112 includes or does not include deepfake-generated voice. Either the deepfake detection components 108 or another component of the telecommunication network 110 may then generate the alert message 114 based on the determination of the deepfake detection components 108.

FIG. 2 is a network architecture diagram showing components of a telecommunication network capable of detecting a deepfake-generated voice of a calling party and alerting the called party about the deepfake-generated voice.

As shown in FIG. 2, a calling party 202 and a called party 204 may each include/use a UE. Such UEs may be any sort of device(s) capable of engaging in voice communication over a network and may each be a different type of device for each of the calling party 202 and the called party 204. For example, the UE of the calling party 202 may be a computing device with a fixed or mobile location and may even be a group of devices. Examples include personal computers (PCs), servers, datacenter devices, laptops, etc. The UE of the calling party 202 may include an application and interface for engaging in voice communication over a network. The UE of the called party 204 may, but need not be, a mobile device such as a cellular phone, a personal digital assistant (PDA), a tablet computer, a laptop, a PC, a watch, a headset, glasses, a vehicle, an Internet of Things (IoT) device, etc. The UE of the called party 204 may also include an application and interface for engaging in voice communication over a network. Further, in some implementations, the UEs of the calling party 202 and called party 204 may be the same type of device or may be switched from the examples above (e.g., the UE of the calling party 202 may be a tablet computer). The entity speaking on the UE of the calling party 202 may be an application or service capable of generating deepfake voice audio to sound like it is spoken by a human. The entity using the UE of the called party 204 may be a human person.

The RAN 206 is shown as a single radio access network (RAN); it is to be understood however that the RAN 206 may represent two different RANs of a same telecommunication network or of different telecommunication networks. Further, while referred to as a “RAN”, RAN 206 may comprise other types of access networks. The RAN 206 may support any or all of licensed radio frequency (RF) communication (e.g., cellular), unlicensed RF communication (e.g., WiFi), other RF communication types, wired communications (e.g., ethernet), etc.

In various implementations, the core network 208 may represent a core network of a single telecommunication network which both the calling party 202 and called party 204 are connected to through RAN 206. The calling party 202 and called party 204 may each be connected to a different telecommunication network, and the core network 208 may belong to either of those. Alternatively, both telecommunication networks could have core networks 208 with some or all of the components shown in FIG. 2 as belonging to core network 208. In some examples, each core network 208 could have a subset of those components.

In addition to the components shown in FIG. 2, the core network 208 may also include other components or nodes. For example, in a Fourth Generation (4G) core network 208, the core network 208 may include a mobility management entity (MME), a serving gateway (S-GW), a packet data network gateway (P-GW), a policy and charging rules function (PCRF), a home subscriber server (HSS), a short message service center (SMSC), etc. The core network 208 may be a different generation of core network (e.g., Fifth Generation (5G), Sixth Generation (6G), Third Generation (3G), etc.) with corresponding different components or nodes. Regardless of the generation, however, the core network 208 may have the components shown in FIG. 2 or their functions distributed in some manner.

In various implementations, the IMS 210 may be any sort of IMS and may include a proxy call session control function (P-CSCF) 212, a serving call session control function (S-CSCF), an interrogating call session control function (I-CSCF), a telephony application server (TAS), etc. Some of these roles may be combined in a single node of the IMS 210, such as an I/S-CSCF. The P-CSCF 212 may serve as an entry point to the IMS 210 and, as described herein, may capture the voice audio of the calling party 202. For example, the voice audio of the calling party 202 may be an RTP stream and the P-CSCF 212 may fork an initial part of that RTP stream (e.g., 1.5 to 5 seconds worth—or some corresponding number of data packets) to another device or component, such as the sampling component(s) 214. The P-CSCF 212 capturing the voice audio may be an originating P-CSCF 212 (P-CSCF of the calling party's telecommunication network) or a terminating P-CSCF 212 (P-CSCF of the called party's telecommunication network). Also, the voice audio may be captured following a setup of the communication session using, e.g., SIP signaling.

The sampling component(s) 214 may be a single node multiple nodes of the core network 208. In some examples, the sampling component(s) 214 may include a recording client 216 and a session server 218. The recording client 216 may receive the voice audio from the P-CSCF 212 and buffer the received packets of voice audio until a desired number of packets/time length is reached. At that point, the recording client 216 may forward the buffered voice audio to the session server 218 and clear the contents of the buffer. The session server 218 may encode the buffered voice audio as a media file (e.g., as a. wav file) and discard the buffered voice audio. The media file—also referred to herein as the voice audio sample—may then be sent to the deepfake detection component 220.

The deepfake detection component 220 may utilize one or more models 222, such as voice verification models, to determine whether the voice audio sample includes deepfake-generated voice. Applying the model(s) 222 may involve analyzing the voice audio sample for biometric markers such as pitch, harmonics, resonant harmonics, intensity, rhythms, spacing between words, pronunciations, etc. After analyzing the voice audio sample, the voice audio sample may be discarded. If the voice audio sample includes deepfake-generated voice, the deepfake detection component 220 may send an alert itself to the called party 204 or send a signal to a scam protection service 224 of the core network 208, which may then send an alert to the called party 204.

The scam protection service 224 may provide called party 204 and other subscribers to a telecommunication network operator that implements the scam protection service 224 with at least deepfake detection and alert services. It may also provide other services, such as caller identification of suspicious numbers, preemptive termination of known scam calls, etc. In some implementations, either through a scam protection application 226 on the UE of the called party 204 or through a web portal associated with the scam protection service 224, the scam protection service 224 may enable the called party 204 to opt-in to receiving alerts of deepfake-generated voice or to opt-out of receiving such alerts. The scam protection application 226 or web portal may also allow the called party 204 to select among other action(s) to take if the communication session includes deepfake-generated voice, such as terminating the communication session. The form of the alert triggered may also be configured, such as vibrating, message receipt and display, playing of a tone, etc. In one example, the alert may be a short message service (SMS) message with a binary payload. Such SMS messages with binary payloads do not show up in a user's text message history. Alternatively, the alert message may be communicated by, e.g., an application programming interface (API) call from the scam protection service 224 to the scam protection application 226. The web portal also indicates to the called party 204 by opting in to the receiving the alerts, the called party 204 is consenting to audio recordings of incoming communication sessions received by the called party 204 at the UE on the telecommunication network for automated deepfake audio analysis.

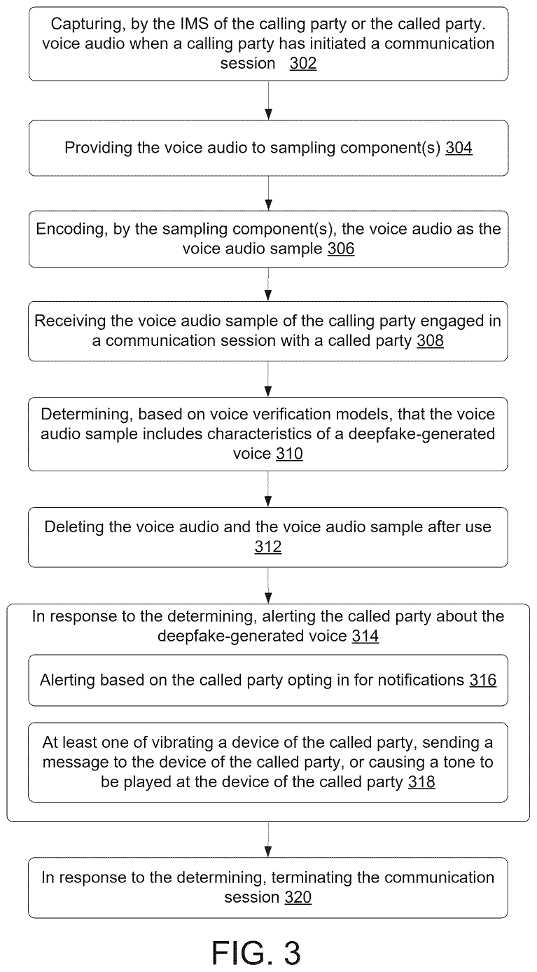

FIG. 3 illustrates an example process. This process is illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 3 is a flow diagram of an illustrative process for receiving, by a PCF, a message from another node that includes a vendor indicator, determining a policy for the other node based at least in part on the vendor indicator, and sending the policy to the other node. As illustrated at 302, when a calling party has initiated a communication session, the IMS of the calling party or the called party may capture voice audio and, at 304, provide the voice audio to sampling component(s) for recording. Such capture and recording may be performed subject to any consent requirement and/or permission by applicable laws and regulations. For example, in some instances, prior to initiating voice audio capture, the IMS may initiate a playback of an automated message to the calling party indicating that the communication session is being audio recorded for automated scam detection and the calling party continuing with the communication session constitutes consent. At 306, the sampling component(s) may encode the voice audio as the voice audio sample. In some implementations, the voice audio may be an RTP stream forked by the IMS to the sampling component(s). Further, the voice audio sample may represent voice audio from an initial time period in the communication session.

At 308, one or more computing devices may receive the voice audio sample of the calling party engaged in a communication session with a called party. For example, a deepfake detection component may receive the voice audio sample from the sampling component(s). At 310, one or more computing devices may determine, based on voice verification models, that the voice audio sample includes characteristics of a deepfake-generated voice. In some implementations, the voice verification models may utilize biometric markers.

At 312, in various implementations, the one or more computing devices may then delete the voice audio and the voice audio sample after use.

At 314, in response to the determining, the one or more computing devices may alert the called party about the deepfake-generated voice. At 316, the alerting may comprise alerting based on the called party opting in for notifications. At 318, the alerting may include at least one of vibrating a device of the called party, sending a message to the device of the called party, or causing a tone to be played at the device of the called party. For example, in some instances, an alert may indicate that the calling party may potentially be an impersonator and the called party should verify the identity of the calling party if possible before continuing the call. At 320, in response to the determining, the one or more computing devices may alternatively or concurrently terminate the communication session. In some implementations, action(s) taken in response to the determining may be configurable by the called party.

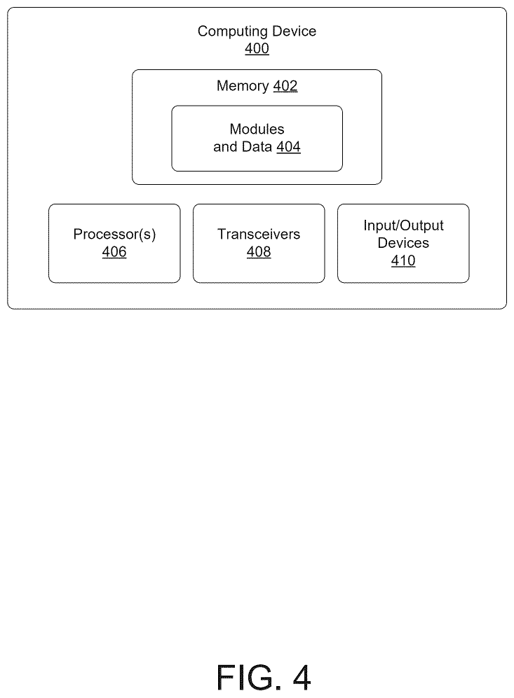

FIG. 4 is a schematic diagram of a computing device capable of implementing functionality of at least one of the components illustrated in FIG. 1 or FIG. 2. As shown, the computing device 400 includes a memory 402 storing modules and data 404, processor(s) 406, transceivers 408, and input/output devices 410.

In various examples, the memory 402 can include system memory, which may be volatile (such as RAM), non-volatile (such as ROM, flash memory, etc.) or some combination of the two. The memory 402 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 402 can include one or more software or firmware elements, such as computer-readable instructions that are executable by the one or more processors 406. For example, the memory 402 can store computer-executable instructions associated with modules and data 404. The modules and data 404 can include a platform, operating system, and applications, and data utilized by the platform, operating system, and applications. Further, the modules and data 404 can implement any of the functionality for the devices and components described and illustrated herein.

In various examples, the processor(s) 406 can be a central processing unit (CPU), a graphics processing unit (GPU), or both CPU and GPU, or any other type of processing unit. Each of the one or more processor(s) 406 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 406 may also be responsible for executing all computer applications stored in the memory 402, which can be associated with types of volatile (RAM) and/or nonvolatile (ROM) memory.

The transceivers 408 can include modems, interfaces, antennas, Ethernet ports, cable interface components, and/or other components that perform or assist in exchanging wireless communications, wired communications, or both.

While the computing device need not include input/output devices 410, in some implementations it may include one, some, or all of these. For example, the input/output devices 410 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 410 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 410 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

Also, while the descriptions provided herein may be in the context of certain radio access technologies, networks, and network topologies, such as Fifth Generation (5G)/new radio (NR) mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method comprising:
receiving, by one or more computing devices, a voice audio sample of a calling party engaged in a communication session with a called party;
determining, by the one or more computing devices and based on voice verification models, that the voice audio sample includes characteristics of a deepfake-generated voice; and
in response to the determining, alerting, by the one or more computing devices, the called party about the deepfake-generated voice.

2. The method of claim 1, further comprising capturing voice audio by an Internet Protocol Multimedia Subsystem (IMS) of the calling party or the called party and providing the voice audio to sampling component(s) for encoding.

3. The method of claim 2, further comprising encoding, by the sampling component(s), the voice audio as the voice audio sample.

4. The method of claim 3, further comprising deleting the voice audio and the voice audio sample after use.

5. The method of claim 2, wherein the voice audio is a Real-time Transport Protocol (RTP) stream forked by the IMS to the sampling component(s).

6. The method of claim 1, wherein the voice audio sample represents voice audio from an initial time period in the communication session.

7. The method of claim 1, wherein the voice verification models utilize biometric markers.

8. The method of claim 1, wherein the alerting comprises alerting based on the called party opting in for notifications.

9. Then method of claim 1, wherein the alerting includes at least one of vibrating a device of the called party, sending a message to the device of the called party, or causing a tone to be played at the device of the called party.

10. The method of claim 1, further comprising, in response to the determining, terminating the communication session.

11. The method of claim 1, wherein action(s) taken in response to the determining are configurable by the called party.

12. A system comprising:
one or more processors; and
programming instructions that, when executed by the one or more processors, cause the system to perform operations including:
receiving a voice audio sample of a calling party engaged in a communication session with a called party;
determining, based on voice verification models, that the voice audio sample includes characteristics of a deepfake-generated voice; and
in response to the determining, alerting the called party about the deepfake-generated voice.

13. The system of claim 12, wherein the operations further comprise capturing voice audio by an Internet Protocol Multimedia Subsystem (IMS) of the calling party or the called party and providing the voice audio to sampling component(s) for encoding.

14. The system of claim 13, wherein the operations further comprise deleting the voice audio and the voice audio sample after use.

15. The system of claim 12, wherein the voice audio sample represents voice audio from an initial time period in the communication session.

16. The system of claim 12, wherein the voice verification models utilize biometric markers.

17. Then system of claim 12, wherein the alerting includes at least one of vibrating a device of the called party, sending a message to the device of the called party, or causing a tone to be played at the device of the called party.

18. A non-transitory computer-storage medium having programming instructions stored thereon that, when executed by one or more processors of one or more computing devices cause the one or more computing devices to perform operations comprising:
receiving a voice audio sample of a calling party engaged in a communication session with a called party;
determining, based on voice verification models, that the voice audio sample includes characteristics of a deepfake-generated voice; and
in response to the determining, alerting the called party about the deepfake-generated voice.

19. The non-transitory computer-storage medium of claim 18, wherein the voice audio sample represents voice audio from an initial time period in the communication session.

20. Then non-transitory computer-storage medium of claim 18, wherein the alerting includes at least one of vibrating a device of the called party, sending a message to the device of the called party, or causing a tone to be played at the device of the called party.
